(19) United States
(12) Patent Application Publication
(10) Pub. No.: US 2010/0067807 A1
(43) Pub. Date: Mar. 18, 2010

(54) SYSTEM AND METHOD FOR VERIFICATING ELECTRIC DOCUMENT AND SYSTEM FOR PROVIDING ELECTRIC DOCUMENT SERVICE

(75) Inventors: Kyu Tae Kim, Seoul (KR); Jeong Uk Yang, Gyeonggi-do (KR); Yun Seong Choi, Seoul (KR)

Correspondence Address: OCCHIUTI ROHLICEK & TSAO, LLP, 10 FAWCETT STREET, CAMBRIDGE, MA, 02138, US

(73) Assignee: Markany Inc., Seoul (KR)

(21) Appl. No.: 12/516,241

(22) PCT Filed: Nov. 22, 2007
(86) PCT No.: PCT/KR07/05902

§ 371 Date: May 26, 2009

(30) Foreign Application Priority Data
Nov. 28, 2006 (KR) 10-2006-0118167

(51) Int. Cl. G06K 9/68

(52) U.S. Cl. 382/218

(57) ABSTRACT

A method and system for verifying an electronic document and a system for providing an electronic document service are provided. The system for verifying the electronic document includes: an image data acquisition unit acquiring an image of the electronic document by scanning the electronic document; a barcode detection unit detecting a barcode inserted into a predetermined position in the acquired image of the electronic document and acquiring first electronic document data; an image data conversion unit generating second electronic document data by converting a format of the acquired image of the electronic document into a format that can be compared with the first electronic document data; a falsification determination unit de [symbol] termining whether the electronic document is falsified by comparing the first electronic document data with the second electronic document data; and a display unit displaying the fa [symbol] sification determination result determined by the falsification determination unit. Accordingly, it is possible to automatically verify whether the electronic document is falsified by comparing the first document information obtained by scanning the electronic document that is issued on-line and output with the second document information recovered from the barcode included in the electronic document.

### TECHNICAL FIELD

The present invention relates to a method and system for verifying an electronic document and a system for providing an electronic document service, and more particularly, to a technique for verifying whether an electronic document is falsified capable of automatically verifying whether an electronic document that is issued online is falsified.

### BACKGROUND ART

Recently, as wired or wireless communication services such as mobile communication or super-high speed Internet services have been generally provided, it is possible to substitute on-line operations for most operations that are performed off-line in the past. Specifically, market shares of services of providing various types of information on-line, electronic commercial services, and the like are increased as compared those of off-line services corresponding thereto. This trend will be more speedily progressed.

On-line civil application services are substituted for existing off-line civil application services in government agencies such as village offices, registry offices, district offices, and the like, in addition to private agencies such as general companies, financial agencies, and the like. There are various on-line civil application services. The typical service of the on-line civil application services is a service of issuing an electronic document.

Since various types of documentation is issued on-line through the service of issuing an electronic document, a user can receive desired documentation by only performing a predetermined authentication procedure on-line without inviting an issuing agency. The user can receive a desired document without limitation of time and space through the service of issuing an electronic document. In addition, the issuing agency can improve efficiency of businesses by reducing labor costs, simplifying issuing procedures, and reducing an issuing time.

However, despite these advantages, the service of issuing an electronic document is vulnerable to falsification of the electronic document. Accordingly, in order to use the service of issuing an electronic document, a security technique for strictly securing reliability of the electronic document is required. Specifically, as the number of electronic documents that are issued per year is exponentially increased, the security technique for the electronic document becomes more important.

In the past, a technique for checking whether an electronic document is falsified by inserting a barcode for verifying whether the electronic document is falsified when issuing the electronic document was mainly used. At this time, the barcode is classified into a linear one-dimensional (1D) barcode and a two-dimensional (2D) barcode that is manufactured as a predetermined image. The 1D barcode includes only limited data. On the contrary, the 2D barcode can include relatively large capacity of data. Recently, the 2D barcode is mainly used.

In a conventional technique for checking whether the electronic document is falsified, by using the 2D bar code, the agency for issuing the electronic document issues the electronic document to the user by inserting a 2D barcode including image information on the electronic document into the electronic document, when issuing the electronic document. Then, the user can submit the issued electronic document to various agencies as documentation. At this time, a receiving agency displays the image information on the electronic document by decrypting the 2D barcode inserted into the electronic document submitted by the user through a predetermined system. Then, a staff determines whether the electronic document is falsified by comparing the displayed image information on the electronic document with the submitted electronic document through naked eyes.

However, in this conventional case, since a staff of the receiving agency has to compare images that are recovered through 2D bar codes with received electronic documents one by one, it takes too much time to check whether the electronic documents are falsified. Accordingly, efficiency of businesses is decreased. In addition, a probability of occurrence of an error is increased due to manual procedures of checking whether the electronic documents are falsified. Accordingly, reliability of checking whether the electronic document is falsified is decreased.

### DISCLOSURE OF INVENTION

### Technical Problem

The present invention provides a system for verifying an electronic document capable of automatically checking whether the electronic document is falsified by using a barcode inserted into the electronic document.

The present invention also provides a method of verifying an electronic document capable of providing a procedure of automatically checking whether the electronic document is falsified by using a barcode inserted into the electronic document.

The present invention also provides a system for providing an electronic document service capable of issuing an electronic document by inserting an encrypted barcode including contents of the electronic document into the electronic document when issuing the electronic document and capable of verifying whether the electronic document is falsified by using information on the barcode when submitting the issued electronic document.

### Technical Solution

According to an aspect of the present invention, there is provided a system for verifying an electronic document, the system comprising: an image data acquisition unit acquiring an image of the electronic document by scanning the electronic document; a barcode detection unit detecting a barcode inserted into a predetermined position in the acquired image of the electronic document and acquiring first electronic document data; an image data conversion unit generating second electronic document data by converting a format of the acquired image of the electronic document into that of the acquired image that can be compared with the first electronic document data; a falsification determination unit determining whether the electronic document is falsified by comparing the first electronic document data with the second electronic document data; and a display unit displaying the falsification determination result determined by the falsification determination unit.

In the above aspect of the present invention, the system for verifying the electronic document may further comprise: a communication network interface unit providing a communication network interface function so as to interact with an electronic document issuing system through a communication network; and a control unit transmitting information on the falsification determination result to the electronic document issuing system based on the falsification determination result.

In addition, when it is determined that the electronic document is falsified, the control unit may transmit a report message for reporting that the electronic document is falsified to the electronic document issuing system. In addition, the control unit that provides a report button on the display unit transmits a report message to the electronic document issuing system, when the report button is pressed by a checker.

In addition, the control unit may transmit a receipt verification message for representing that the electronic document is normally received to the electronic document issuing system, when it is determined that the electronic document is not falsified. In addition, the control unit may recognize the electronic document issuing system from predetermined information or the barcode.

In addition, the barcode may be a 2D barcode obtained by encrypting information that includes contents of the electronic document.

In addition, the image data conversion unit that includes an optical character recognition (OCR) processor may generate the second electronic document data by converting the acquired image of the electronic document into text information that can be compared with the first electronic document data. In this case, the falsification determination unit may compare main texts of the first and second electronic document data. In addition, the image data conversion unit may generate the second electronic document data by converting a scale and resolution of the acquired image of the electronic document into those of the image that can be compared with the first electronic document data. In this case, the falsification determination unit may compare the first and second electronic document data by recognizing block images including main texts in the first and second electronic document data, recognizing images of parts including text lines in the block images, extracting character images from the recognized images, and overlapping the character images.

According to another aspect of the present invention, there is provided a method of verifying an electronic document, the method comprising: acquiring an image of the electronic document by scanning the electronic document; detecting a barcode inserted into a predetermined position in the acquired image of the electronic document; acquiring first electronic document data by decrypting the detected bar code; generating second electronic document data by converting a format of the acquired image of the electronic document into a format o the acquired image that can be compared with the first electronic document data; determining whether the electronic document is falsified by comparing the first electronic document data with the second electronic document data; and displaying the falsification determination result determined by the falsification determination unit.

In addition, the method of verifying the electronic document may further comprise transmitting information on the falsification determination result to the electronic document issuing system. In addition, the transmitting the information may include transmitting a report message for reporting that the electronic document is falsified to the electronic document issuing system when it is determined that the electronic document is falsified and transmitting a receipt verification message for representing that the electronic document is normally received to the electronic document issuing system when it is determined that the electronic document is not falsified.

In addition, in the displaying the falsification determination result, a report button for reporting that the electronic document is falsified based on a request of a checker is provided, and in the transmitting the information on the falsification determination result, when the report button is pressed by the checker, the report message is transmitted to the electronic document issuing system.

In addition, the generating the second electronic document data may include converting the acquired image of the electronic document into text information that can be compared with the first electronic document data through an OCR process. In addition, the determining whether the electronic document is falsified may include checking whether there is any unmatched item by comparing the second and first electronic document data.

According to another aspect of the present invention, there is provided a system for providing an electronic document service, the system comprising: an electronic document issuing system issuing the electronic document by inserting an encrypted barcode including contents of an electronic document into a predetermined position in the electronic document, when a user requests the electronic document; and an electronic document verification system capable of verifying whether the electronic document is falsified by acquiring an image of the issued electronic document, acquiring first electronic document data by detecting the barcode inserted into the predetermined position in the electronic document from the acquired image of the electronic document and decrypting the detected bar code, generating second electronic document data by converting the acquired image of the electronic document into data that can be compared with the first electronic document data, and comparing the first electronic document data with the second electronic document data.

In the above aspect of the present invention, the electronic document verification system may display a result obtained by comparing the first and second electronic document data. In addition, the electronic document verification system may transmit information on the falsification verification result of the electronic document to the electronic document issuing system.

In addition, the electronic document verification system may transmit the information on the falsification verification result to the electronic document issuing system as a report message or receipt verification message and store and manage the transmitted report message or transmitted receipt verification message by distinguishing the report message from the receipt verification message.

### Advantageous Effects

As described above, it is possible to automatically verify whether an electronic document is falsified by comparing first document information obtained by scanning the electronic document that is issued on-line and output with second document information recovered from a barcode included in the electronic document. Accordingly, it is possible to increase efficiency in human resources and time resources for verifying whether the electronic document is falsified and improve reliability of the verification.

### BRIEF DESCRIPTION OF THE DRAWINGS

FIG. 1 is a block diagram illustrating a structure of an electronic document service system for issuing and verifying an electronic document.

FIG. 2 is a block diagram illustrating a detailed structure of an electronic document verification system according to an exemplary embodiment of the present invention.

FIG. 3 is a flowchart of a method of verifying an electronic document according to an exemplary embodiment of the present invention.

FIG. 4 illustrates an example of a falsification determination result displayed by an electronic document verification system.

### MODE FOR THE INVENTION

Now, preferred embodiments of the present invention will be described in detail with reference to the attached drawings. In addition, in order to clearly describe exemplary embodiments with reference to the accompanying drawings, specific technical terms are used. However, the present invention is not limited to the selected specific technical terms, and each specific technical term includes all the technical synonyms which operate in a similar manner so as to achieve a similar entity.

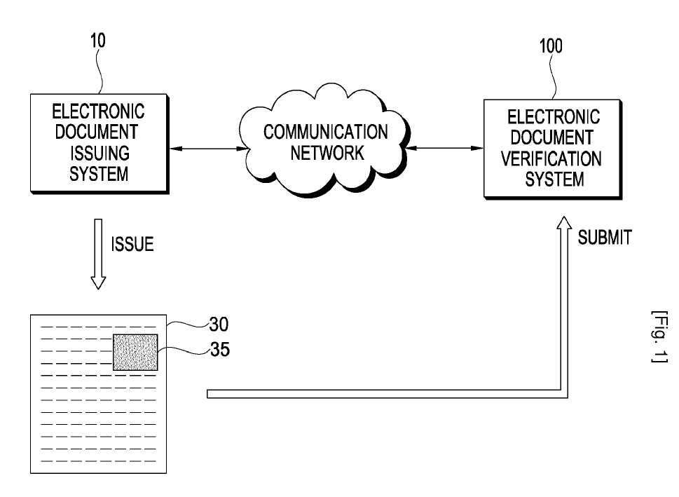

FIG. 1 is a block diagram illustrating a structure of an electronic document service system for issuing and verifying an electronic document. FIG. 1 illustrates a structure of a system to which the electronic verification system according to an exemplary embodiment of the present invention can be applied.

As shown in FIG. 1, in order to issue and verify the electronic document, an electronic document issuing system 10 and an electronic document verification system 100 are required.

The electronic document issuing system 10 issues an electronic document 30. A two-dimensional (2D) barcode 35 for verifying whether the electronic document is falsified when the electronic document 30 is submitted is inserted into a predetermined position in the electronic document 30. The 2D barcode 35 includes contents of the electronic document 30, for example, a text of the electronic document 30. The 2D barcode is encrypted by using a predetermined encryption algorithm. That is, the 2D barcode 35 includes information for acquiring contents of the electronic document 30. On the other hand, although the contents of the electronic document 30 included in the 2D barcode 35 may be a text, the contents of the electronic document 30 is not limited to the text. The contents of the electronic document 30 may be an image.

A user may receive the electronic document through a predetermined authentication process after accessing the electronic document issuing system 10 by using a terminal (not shown). Alternatively, the user may receive the electronic document 30 from the electronic document issuing system 10 that is located in an issuing agency or a predetermined place.

The user who receives the electronic document 30 can submit the electronic document 30 to a desired submitting agency. The submitting agency includes the electronic document verification system 100. The electronic document verification system 100 verifies whether the electronic document 30 submitted by the user is falsified and displays the verification result. For example, the electronic document verification system 100 can compare the submitted electronic document 30 with the information obtained by recovering the 2D barcode 35 that is inserted into the electronic document 30, determine whether the electronic document 30 is falsified, and display the determination result. A checker of the submitting agency can easily recognize whether the electronic document 30 is falsified and perform subsequent operations such as a report.

On the other hand, the electronic document verification system 100 can interact with the electronic document issuing system 10 through a communication network. For example, when the electronic document verification system 100 recognizes that the electronic document 30 is falsified, the electronic document verification system 100 can report to the electronic document issuing system 10 that the electronic document 30 is falsified. The electronic document issuing system 10 may manage the reported information.

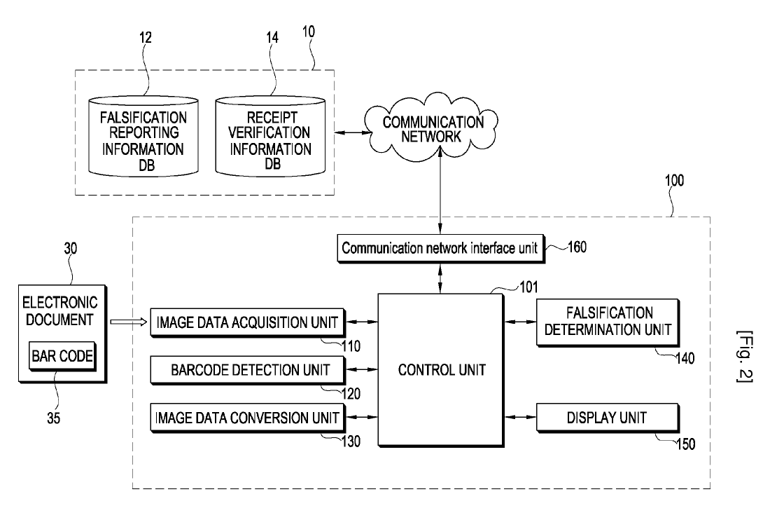

FIG. 2 is a block diagram illustrating a detailed structure of an electronic document verification system 100 according to an exemplary embodiment of the present invention.

As shown in FIG. 2, the electronic document verification system 100 according to the exemplary embodiment includes a communication network interface unit 160, an image data acquisition unit 110, a barcode detection unit 120, an image conversion unit 130, a falsification determination unit 140, a display unit 150, and a control unit 101.

The communication network interface unit 160 performs a communication network interface function so as to enable the electronic document verification system 100 to interact an external system through the wired or wireless Internet. The electronic document verification system 100 can transmit and receive information to and from the electronic document issuing system 10.

The image data acquisition unit 110 serves to acquire an image of the electronic document 30 by scanning the electronic document 30. As described above, the electronic document 30 may be submitted by the user. The 2D barcode 35 was inserted into a predetermined position in the electronic document 30. For example, as is not shown, the image data acquisition unit 110 may include a scanner capable of scanning the electronic document 30 and a scanner interface capable of interfacing interaction between the scanner and the control unit.

The barcode detection unit 120 detects the 2D barcode 35 that is inserted into the predetermined position in the image of the electronic document 30 acquired by the image data acquisition unit 110 and acquires first electronic document data from the detected 2D barcode 35. For example, the barcode detection unit 120 can detect the 2D barcode 35 that is inserted into the predetermined position in the acquired image of the electronic document 30 and acquire first electronic document data having a text type by decrypting the detected 2D barcode 35. Alternatively, the barcode detection unit 120 can acquire the first electronic document data having an image type by decrypting the detected 2D barcode 35 and converting the decrypted 2D barcode 35 into an image.

Since the 2D barcode 35 is encrypted information including the contents of the electronic document 30, it is possible to acquire the contents of the electronic document 30 (for example, the text of the electronic document 30) by decrypting the 2D barcode 35. That is, the first electronic document data may indicate text or image information including original contents of the electronic document 30.

The image data conversion unit 130 generates second electronic document data by converting the image of the electronic document 30 acquired by the image data acquisition unit 110 into data that can be compared with the first electronic document data. For example, the image data conversion unit 130 that includes an optical character recognition (OCR) processor can convert the image of the acquired electronic document 30 into text information that can be compared with the first electronic document data. On the other hand, if the first electronic document data is image information, the image data conversion unit 130 can convert a scale, resolution, and the like of the acquired image of the electronic document 30 into those of the acquired image of the electronic document that can be easily compared with the first electronic document data.

The falsification determination unit 140 determines whether the electronic document 30 is falsified by comparing the first electronic document data acquired by the barcode detection unit 120 with the second electronic document data converted by the image data conversion unit 130. That is, the falsification determination unit 140 determines whether the electronic document 30 is falsified by comparing the contents of the electronic document recovered through the 2D barcode 35 with the image of the electronic document 30 obtained through a real scanning process.

For example, if the first and second electronic document data is text information, the falsification determination unit 140 can determine whether the electronic document 30 is falsified by comparing main texts of two pieces of information. At this time, the main texts for comparing the two pieces of information with each other may be previously determined. On the other hand, if the first and second electronic document data is image information, the falsification determination unit 140 can determine whether the electronic document 30 is falsified by comparing an image included a predetermined part of the first electronic document data with a corresponding image included in a predetermined part of the second electronic document data. For example, the falsification determination unit 140 can compare the first and second electronic document data by recognizing block images including main texts in the first and second electronic document data, recognizing images of parts including text lines in the block images, extracting character images from the recognized images, and overlapping the character images.

That is, it is determined whether predetermined character images of the first electronic document data is the same as those of the second electronic document data by overlapping the character images of the first and second electronic document data.

The display unit 150 displays information on the falsification determination result determined by the falsification determination unit 140 on a screen. Preferably, the display unit 150 concurrently displays the first and second electronic document data on the same screen so that the checker who checks the falsification of the electronic document 30 can easily recognize the falsification determination result. The display unit 150 can display different items, that is, items which may be falsified. This will be described later in detail.

The control unit 101 serves to control cooperation of the aforementioned units and an entire data flow based on a falsification verification process. In addition, the control unit 30 can transmit information on the falsification determination result determined by the falsification determination unit 140 to the electronic document issuing system 10 by controlling the communication network interface unit 160. The information on the falsification determination result may include information on falsification determination bases (for example, the comparison result and different items) and the like. The information on the falsification determination result may be transmitted in a form of a report message or receipt verification message based on whether the electronic document is falsified. The report message indicates a message for reporting that the electronic document is falsified, if the electronic document 30 is falsified. The receipt verification message indicates a message for reporting that the electronic document 30 is normally received without falsification.

The information on the falsification determination result may be transmitted in response to a request of the electronic document checker or automatically transmitted. For example, when the falsification determination result is displayed, the control unit 101 provides a report button on a screen through a display unit 150. When the checker presses the report button, the report message is transmitted. When the report button is not pressed (or normal verification button, for example, confirm is pressed), the receipt verification message for representing that the electronic document 30 is normally received is transmitted to the electronic document issuing system 10. Here, the pressing operation includes an operation of requesting a specific function such as a click operation by the user. On the other hand, after the control unit 101 previously sets predetermined falsification determination standards (for example, when the first electronic document data is not matched with the second electronic document data, it is determined that the electronic document is falsified, or when the first electronic document data is matched with the second electronic document data in parts equal to or less than 95% of the electronic document, it is determined that the electronic document is falsified), the control unit 101 may automatically transmit the report message or receipt verification message to the electronic document issuing system 10 based on the falsification determination standards. That is, information on the falsification determination result may be transmitted in response to a selection of the user or automatically transmitted.

The control unit 101 may transmit information on the falsification determination result to the electronic document issuing system 10 that is previously designated through environment settings. Alternatively, the control unit 101 may transmit information on the falsification determination result to the electronic document issuing system 10 by recognizing an electronic document issuing system 10 from information on the 2D barcode 35. In the latter case, the information on the 2D barcode 35 may include information for recognizing the electronic document issuing system 10. On the other hand, information on the electronic document issuing system which is obtained from the information on the 2D barcode is presented to the checker. The checker may select the information and determine whether the electronic document is to be transmitted.

The transmitted information on the falsification determination result may be stored and managed in the falsification report information database 12 or receipt verification information database 14. The falsification report information database 12 stores information transmitted through the report message, for example, information on the electronic document determined to be falsified, information on reports, and the like. The receipt verification information database 14 stores information that is transmitted through the receipt verification message, for example, information on an electronic document that is determined not to be falsified and normally received, receipt information, and the like.

On the other hand, the electronic document verification system 100 may be embodied through a personal computer. The scanner of the image data acquisition unit 110 may be embodied as an external device connected to the personal computer. In this case, the personal computer may include a scanner interface for interfacing with the scanner.

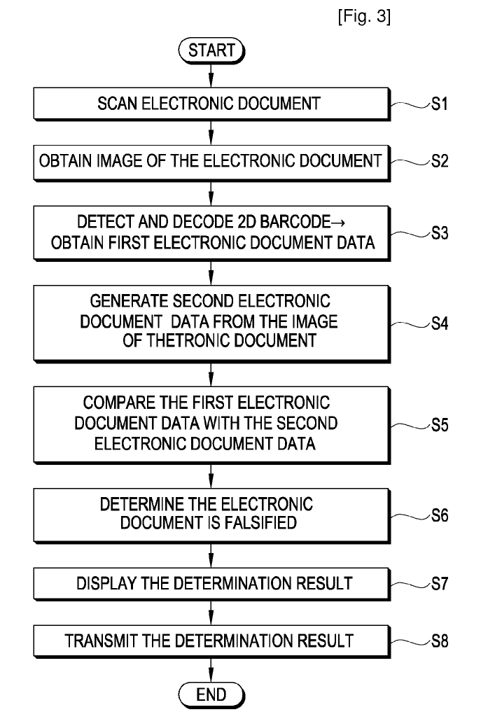

FIG. 3 is a flowchart of a method of verifying an electronic document according to an exemplary embodiment of the present invention.

Referring to FIGS. 1 to 3, the user receives an electronic document 30 from an electronic document issuing system 10 on-line or off-line. A 2D barcode 35 is inserted into a predetermined position in the electronic document 30. The 2D barcode 35 is obtained by encrypting information such as contents of the electronic document 30, for example, a text of the electronic document 30. The user who receives the electronic document 30 can submit the received electronic document 30 to the submitting agency. At this time, the submitting agency includes an electronic document verification system 100. The checker who works in the submitting agency can easily recognize whether the submitted electronic document is falsified by the operation of the electronic document verification system 100.

First, the electronic verification system 100 scans the submitted electronic document 30 (operation S1) and acquires an image of the electronic document 30 (operation S2). Then, the 2D barcode 35 located at the predetermined position in the image is detected. First electronic document data is acquired from the detected 2D barcode 35 (operation S3). As described above, since the 2D barcode 35 is encrypted data including the content of the electronic document 30, for example, the text of the electronic document, the first electronic document data acquired from the 2D barcode 35 includes the contents of the electronic document 30. As described above, the first electronic document data may be text information or image information. The first electronic document data is used as data to be compared, when it is determined whether the electronic document is falsified.

Then, the electronic document verification system 100 generates second electronic document data by converting a format of the acquired image of the electronic document 30 into that of image that can be compared with the first electronic document data (operation S4). For example, the electronic document verification system 100 can convert the scan image of the acquired electronic document 30 into text information that can be compared with the first electronic document data by performing an OCR process. On the other hand, if the first electronic document data is image information, the electronic document verification system 100 can change a scale or resolution of the acquired image of the electronic document, so that the acquired image can be compared with the image of the first electronic document data.

As described above, when the first and second electronic document data is generated, the electronic document verification system 100 compares the second electronic document data with the first electronic document data (operation S5) and determines whether the electronic document is falsified by checking whether there is any unmatched item (operation S6). That is, it is determined whether the electronic document is falsified by comparing the contents of the electronic document recovered through the 2D barcode with the contents obtained from the electronic document obtained through a real scanning process.

It is possible to automatically determine whether the electronic document is falsified based on predetermined determination standards (for example, when there is any unmatched item, it is automatically determined that the electronic document is falsified, or when the first electronic document data is not matched with the second electronic document data in parts more than a predetermined percent of the electronic document). On the other hand, the comparison result and a fact whether the data items are matched are displayed to the checker, and the checker may be enabled to check whether the electronic document is falsified.

When it is determined that the electronic document is falsified, the electronic document verification system 100 displays the falsification determination result (operation S7). At this time, the electronic document verification system 100 displays the first and second electronic document data on the same screen, so that the checker who checks the electronic document 30 can easily recognize the falsification determination result. The electronic document verification system 100 can display different items, that is, items which may be falsified.

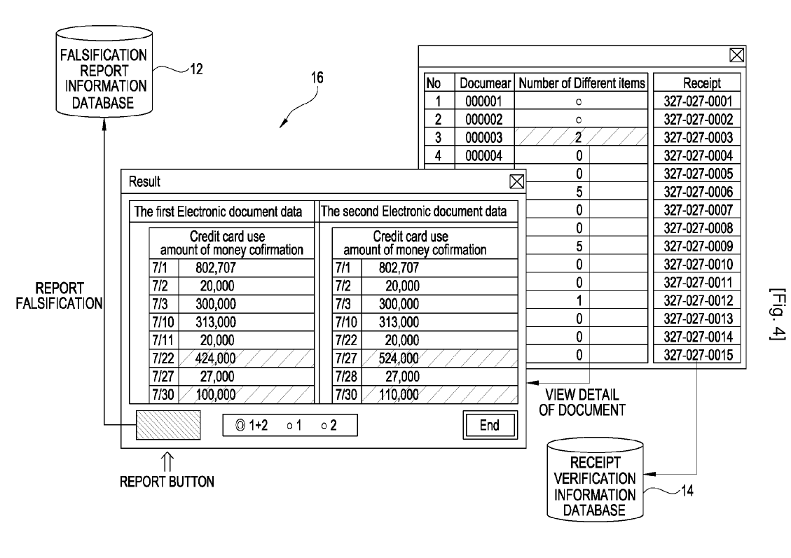

FIG. 4 illustrates an example of a falsification determination result displayed by an electronic document verification system.

As shown in FIG. 4, the first electronic document data is displayed in the left side of a screen 16, and the second electronic document data is displayed in the right side. At this time, the first and second electronic document data is displayed so as to easily recognize the difference in item between the first and second electronic document data.

The electronic document verification system 100 transmits the information on the falsification determination result to the electronic document issuing system 10 based on the falsification determination result (operation S8). The information on the falsification determination result may include information on falsification determination bases (for example, the comparison result, different items) and the like. The information on the falsification determination result may be transmitted by being classified into a report message and a receipt verification message based on whether the electronic document is falsified. The report message is used to report that the electronic document 30 is falsified, if the electronic document 30 is falsified. The receipt verification message is used to report that the electronic document is normally received without falsification.

The information on the falsification determination result may be transmitted in response to a request of the electronic document checker or automatically transmitted. For example, when the falsification determination result is displayed, a report button is provided on a screen. When the user presses the report button, the report message is transmitted. When the user presses a confirm button, the receipt verification message is transmitted. Alternatively, it is possible to automatically transmit the report message or receipt verification message based on the falsification determination result. The information on the falsification determination result may be stored and managed by the electronic document issuing system 10.

While the present invention has been particularly shown and described with reference to exemplary embodiments thereof, it will be understood by those skilled in the art that various changes in form and details may be made therein without departing from the spirit and scope of the present invention as defined by the appended claims.

1. A system for verifying an electronic document, the system comprising:
an image data acquisition unit acquiring an image of the electronic document by scanning the electronic document;
a barcode detection unit detecting a barcode inserted into a predetermined position in the acquired image of the electronic document and acquiring first electronic document data;
an image data conversion unit generating second electronic document data by converting a format of the acquired image of the electronic document into that of the acquired image that can be compared with the first electronic document data;
a falsification determination unit determining whether the electronic document is falsified by comparing the first electronic document data with the second electronic document data; and
a display unit displaying the falsification determination result determined by the falsification determination unit.

2. The system of claim 1, further comprising:
a communication network interface unit providing a communication network interface function so as to interact with an electronic document issuing system through a communication network; and
a control unit transmitting information on the falsification determination result to the electronic document issuing system based on the falsification determination result.

3. The system of claim 2, wherein when it is determined that the electronic document is falsified, the control unit transmits a report message for reporting that the electronic document is falsified to the electronic document issuing system.

4. The system of claim 2, wherein the control unit that provides a report button on the display unit transmits a report message to the electronic document issuing system, when the report button is pressed by a checker.

5. The system of claim 2, wherein the control unit transmits a receipt verification message for representing that the electronic document is normally received to the electronic document issuing system, when it is determined that the electronic document is not falsified.

6. The system of claim 2, wherein the control unit recognizes the electronic document issuing system from predetermined information or the barcode.

7. The system of claim 1, wherein the barcode is a 2D barcode obtained by encrypting information that includes contents of the electronic document.

8. The system of claim 1, wherein the image data conversion unit that includes an OCR (optical character recognition) processor generates the second electronic document data by converting the acquired image of the electronic document into text information that can be compared with the first electronic document data.

9. The system of claim 8, wherein the falsification determination unit compares main texts of the first and second electronic document data.

10. The system of claim 1, wherein the image data conversion unit generates the second electronic document data by converting a scale and resolution of the acquired image of the electronic document into those of the image that can be compared with the first electronic document data.

11. The system of claim 10, wherein the falsification determination unit compares the first and second electronic document data by recognizing block images including main texts in the first and second electronic document data, recognizing images of parts including text lines in the block images, extracting character images from the recognized images, and overlapping the character images.

12. A method of verifying an electronic document, the method comprising:
acquiring an image of the electronic document by scanning the electronic document;
detecting a barcode inserted into a predetermined position in the acquired image of the electronic document;
acquiring first electronic document data by decrypting the detected bar code;
generating second electronic document data by converting a format of the acquired image of the electronic document into a format o the acquired image that can be compared with the first electronic document data;
determining whether the electronic document is falsified by comparing the first electronic document data with the second electronic document data; and
displaying the falsification determination result determined by the falsification determination unit.

13. The method of claim 12, further comprising transmitting information on the falsification determination result to the electronic document issuing system.

14. The method of claim 13, wherein the transmitting the information includes transmitting a report message for reporting that the electronic document is falsified to the electronic document issuing system when it is determined that the electronic document is falsified and transmitting a receipt verification message for representing that the electronic document is normally received to the electronic document issuing system when it is determined that the electronic document is not falsified.

15. The method of claim 13,
wherein in the displaying the falsification determination result, a report button for reporting that the electronic document is falsified based on a request of a checker is provided, and
wherein in the transmitting the information on the falsification determination result, when the report button is pressed by the checker, the report message is transmitted to the electronic document issuing system.

16. The method of claim 13, wherein the determining whether the electronic document is falsified includes checking whether there is any unmatched item by comparing the second and first electronic document data.

17. A system for providing an electronic document service, the system comprising:
an electronic document issuing system issuing the electronic document by inserting an encrypted barcode including contents of an electronic document into a predetermined position in the electronic document, when a user requests the electronic document; and
an electronic document verification system capable of verifying whether the electronic document is falsified by acquiring an image of the issued electronic document, acquiring first electronic document data by detecting the barcode inserted into the predetermined position in the electronic document from the acquired image of the electronic document and decrypting the detected bar code, generating second electronic document data by converting the acquired image of the electronic document into data that can be compared with the first electronic document data, and comparing the first electronic document data with the second electronic document data.

18. The system of claim 17, wherein the electronic document verification system displays a result obtained by comparing the first and second electronic document data.

19. The system of claim 17, wherein the electronic document verification system transmits information on the falsification verification result of the electronic document to the electronic document issuing system.

20. The system of claim 19, wherein the electronic document verification system transmits the information on the falsification verification result to the electronic document issuing system as a report message or receipt verification message and stores and manages the transmitted report message or transmitted receipt verification message by distinguishing the report message from the receipt verification message.
